(19) United States
(12) Patent Application Publication
(10) Pub. No.: US 2009/0013335 A1
(43) Pub. Date: Jan. 8, 2009

(54) SENSOR PROCESS MANAGEMENT METHODS AND SYSTEMS

(75) Inventors: Shang-Ching Hung, Taipei (TW); Shih-Yuan Huang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/774,012

(22) Filed: Jul. 6, 2007

(51) Int. Cl. G06F 9/44

(52) U.S. Cl. 719/321

(57) ABSTRACT

Sensor process management methods and systems are provided. Firstly, a sensor identification and a specific identification are received from a SDR (Sensor Data Record). The specific identification corresponds to one of the multiple sensor modes of a sensor. Then, a ProbeInfo table element is selected according to the sensor identification, and a driver identification is obtained from the selected ProbeInfo table element. Sequentially, a driver corresponding to the driver identification is activated according to the specific identification, and a process is performed under the sensor mode corresponding to the specific identification by the driver.

### BACKGROUND OF THE INVENTION

1. Field of the Invention

The disclosure relates generally to IPMI (Intelligent Platform Management Interface) management, and, more particularly to sensor process management methods and systems.

2. Description of the Related Art

With the popularity of electronic devices, such as computer systems, communication devices, and network devices, performance and execution status of the devices need to be stable. IPMI is an industry-standard protocol defining hardware and firmware monitoring and managing in a computer system, such as monitoring CPU/chip temperature, fan speed and information relative to the chassis, power on/off, and others.

IPMI operates independently from the OS (Operating System) of the computer system and allows system management in the absence of the OS or system management software, or even if the system is not powered on. IPMI defines a plurality of interfaces, such as IPMB (Intelligent Platform Management Bus), KCS (Keyboard Controller Style) (System-BMC interface), UART (Universal Asynchronous Receiver/Transmitter), or LAN (Local Area Network). An IPMI system comprises a BMC (Baseboard Management Controller) coupled with sensors in a chassis, and satellite management controllers via the I²C (Inter-Integrated Chip) implemented IPMB. The BMC receives detected data from the sensors and satellite management controllers, and stores the data in a storage unit, such as EEPROM (Electrically Erasable Programmable Read-Only Memory). Data in the storage unit at least comprises a SDR (Sensor Data Record) repository, a FRU (Field Replaceable Unit), and SELs (System Event Logs). The SDR repository provides the properties of the individual sensors present on the board. For example, sensors may be for temperature, fan speed, voltage, and others. The FRU holds the inventory information, such as vendor id, manufacturer, and others of the devices. The SEL is generated if a specific event occurs. The SEL records the status information of a sensor or the system corresponding to the event. The information in the storage unit can be used for system management.

Generally, a sensor may operate in multiple sensor modes. In respective sensor modes, the sensor performs specific operations correspondingly. For example, a temperature sensor may operate in a first sensor mode supporting Centigrade and a second sensor mode supporting Fahrenheit. Conventionally, if a sensor supports multiple sensor modes, a plurality of drivers must be created for respective sensor modes. FIG. 1 is a schematic diagram illustrating the conventional relationships among SDR, ProbeInfo table element, drivers, and sensor modes. As shown in FIG. 1, respective drivers correspond to a corresponding sensor mode, where driver 1 (113a) corresponds to sensor mode 1 (114a), driver 2 (113b) corresponds to sensor mode 2 (114b), and driver 3 (113c) corresponds to sensor mode 3 (114c). Conventionally, a client may ask to use a specific sensor mode of a sensor, and the sensor provider must provide one of the drivers supporting the specific sensor mode and related data such as ProbeInfo table element 112 in a firmware to the client. The driver may perform processes under the specific sensor mode according to SDR 111 and ProbeInfo table element 112. Since the drivers must be manually changed for different clients having platforms in specific sensor modes, it is inconvenient and time-consuming.

### BRIEF SUMMARY OF THE INVENTION

Sensor process management methods and systems are provided.

In an embodiment of a sensor process management method, a plurality of ProbeInfo table elements is provided. Each ProbeInfo table element corresponds to one of the multiple sensor modes of a sensor and records a specific identification. A sensor identification is received from a SDR (Sensor Data Record), and one of the ProbeInfo table elements is selected according to the sensor identification. A driver identification and the specific identification are obtained from the selected ProbeInfo table element, and a driver corresponding to the driver identification is activated. A process under the sensor mode corresponding to the selected ProbeInfo table element is performed according to the specific identification by the driver.

In an embodiment of a sensor process management method, a sensor identification and a specific identification are received from a SDR (Sensor Data Record), where the specific identification corresponds to one of the multiple sensor modes of a sensor. A ProbeInfo table element is selected according to the sensor identification. A driver identification is obtained from the selected ProbeInfo table element, and a driver corresponding to the driver identification is activated. A process is performed under the sensor mode corresponding to the specific identification according to the specific identification by the driver.

An embodiment of a sensor process management system comprises a storage unit and a processing unit. The storage unit comprises a plurality of ProbeInfo table elements, each corresponding to one of the multiple sensor modes and recording a specific identification, and a SDR (Sensor Data Record) comprising a sensor identification. The processing unit receives the sensor identification from the SDR, and selects one of the ProbeInfo table elements according to the sensor identification. The processing unit obtains a driver identification and the specific identification from the selected ProbeInfo table element, and activates a driver corresponding to the driver identification. The processing unit performs a process under the sensor mode corresponding to the selected ProbeInfo table element according to the specific identification by the driver.

An embodiment of a sensor process management system comprises a storage unit and a processing unit. The storage unit comprises a SDR (Sensor Data Record) comprising a sensor identification and a specific identification corresponding to one of the multiple sensor modes, and a ProbeInfo table element corresponding to the sensor identification and comprising a driver identification. The processing unit receives the sensor identification and the specific identification from the SDR, and selects the ProbeInfo table element according to the sensor identification. The processing unit obtains the driver identification from the selected ProbeInfo table element, and activates a driver corresponding to the driver identification. The processing unit performs a process under the sensor mode corresponding to the specific identification according to the specific identification by the drive.

Sensor process management methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 (Prior Art) is a schematic diagram illustrating the conventional relationships among SDR, ProbeInfo table element, drivers, and sensor modes;

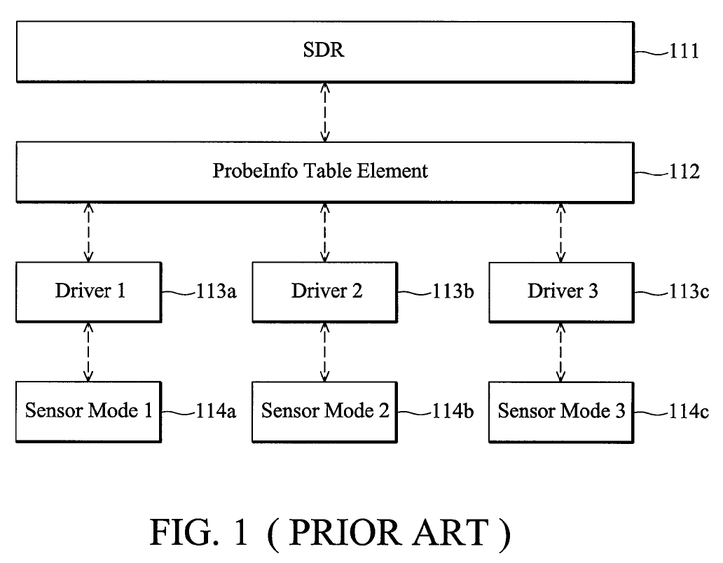

FIG. 2 is a schematic diagram illustrating an embodiment of a sensor process management system;

FIG. 3 is a schematic diagram illustrating the relationships among SDRs, ProbeInfo table elements, an adaptive sensor driver, and sensor modes in FIG. 2;

FIG. 4 is a flowchart of an embodiment of a sensor process management method;

FIG. 5 is a flowchart of an embodiment of a sensor process management method for processing data from a sensor;

FIG. 6 is a schematic diagram illustrating an embodiment of a sensor process management system;

FIG. 7 is a schematic diagram illustrating the relationships among SDRs, a ProbeInfo table element, an adaptive sensor driver, and sensor modes in FIG. 6; and

FIG. 8 is a flowchart of an embodiment of a sensor process management method.

### DETAILED DESCRIPTION OF THE INVENTION

Sensor process management methods and systems are provided.

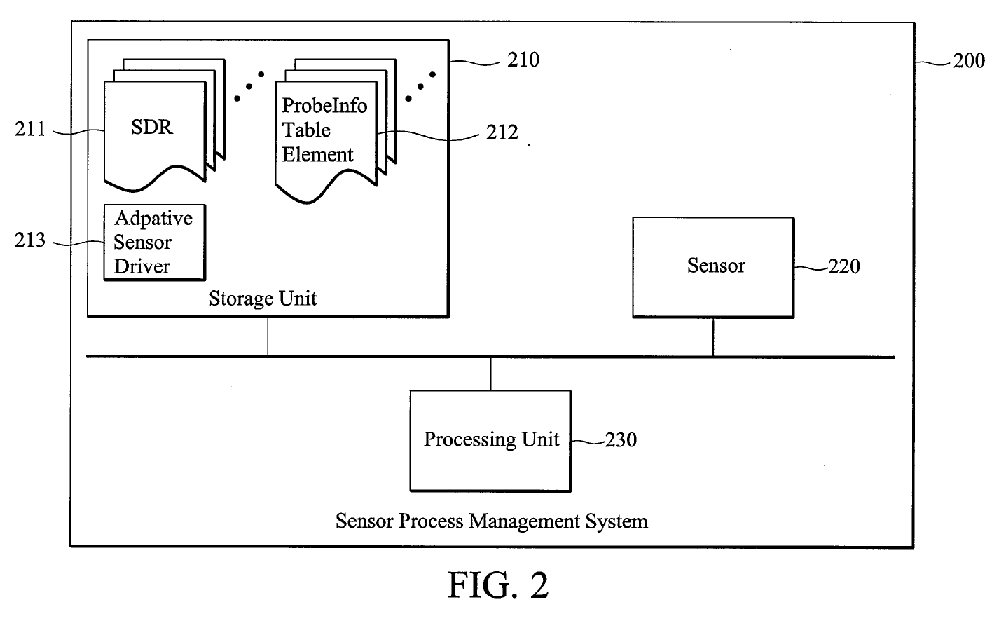

FIG. 2 is a schematic diagram illustrating an embodiment of a sensor process management system. The sensor process management system 200 may be used in an IMPI system. The system 200 comprises at least one storage unit 210, at least one sensor 220, and at least one processing unit 230. The storage unit 210 comprises a plurality of SDRs 211, a plurality of ProbeInfo table elements 212, and at least one adaptive sensor driver 213. In some embodiments, the ProbeInfo table elements 212 and the adaptive sensor driver 213 may be a firmware of the IPMI system. The SDRs 211, the ProbeInfo table elements 212 and the adaptive sensor driver 213 may be stored in the same storage unit or different storage units. The SDRs provide the properties of the individual sensors present on the board. Each SDR 211 comprises a sensor identification such as sensor number or sensor name. It is noted that the sensor number is a unique number identifying the sensor. The sensor name may be recorded in an ID string bytes field of the SDR. Each ProbeInfo table element records driver information such as a driver identification or function point for a driver needed for a sensor/sensor mode. Each ProbeInfo table element 212 comprises a sensor identification to be matched with the SDR 112. Each ProbeInfo table element 212 further comprises a specific identification as information provided to the adaptive sensor driver 213. In this embodiment, each SDR corresponds to a sensor mode of the sensor 220, and has a matched ProbeInfo table element. The adaptive sensor driver 213 can determine a specific process corresponding to a specific sensor mode to be performed according to the information from one of the ProbeInfo table elements. It is understood that the SDRs are different with each other, and that the ProbeInfo table elements are different with each other.

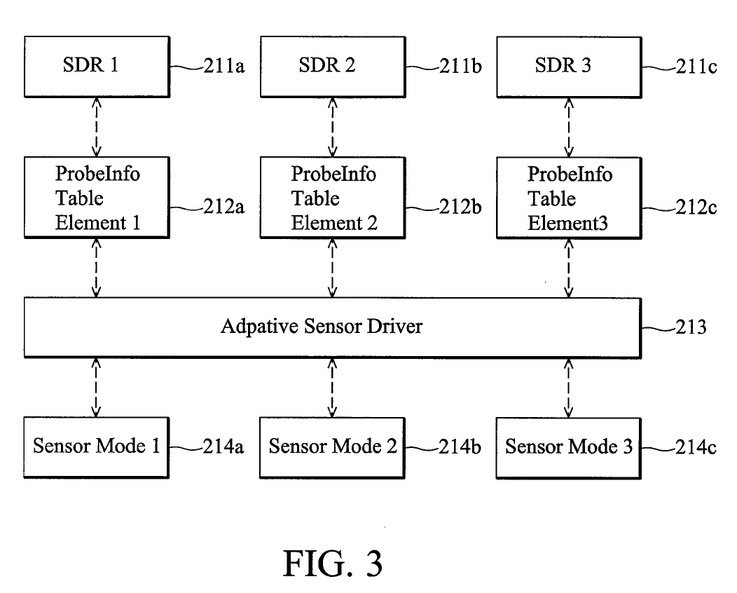

FIG. 3 is a schematic diagram illustrating the relationships among SDRs, ProbeInfo table elements, an adaptive sensor driver, and sensor modes in FIG. 2. As shown in FIG. 3, SDR 1 (211a) corresponds to sensor mode 1 (214a), and has a matched ProbeInfo table element 1 (212a). SDR 2 (211b) corresponds to sensor mode 2 (214b), and has a matched ProbeInfo table element 2 (212b). SDR 3 (211c) corresponds to sensor mode 3 (214c), and has a matched ProbeInfo table element 3 (212c). The adaptive sensor driver 213 performs a process corresponding to one of the sensor modes according to information from the specific ProbeInfo table elements. It is understood that only one sensor, and corresponding sensor modes, SDRs and ProbeInfo table elements are discussed in this embodiment. If several sensors are in the system, the corresponding sensor modes, SDRs and ProbeInfo table elements may be similar to that in FIG. 3. It is understood that, in some embodiments, if several sensors are in the system, several adaptive sensor drivers can be provided to handle processes corresponding to sensor modes of respective sensors. In some embodiments, if several sensors are in the system, an integrated driver can be provided to handle processes corresponding to sensor modes of all sensors.

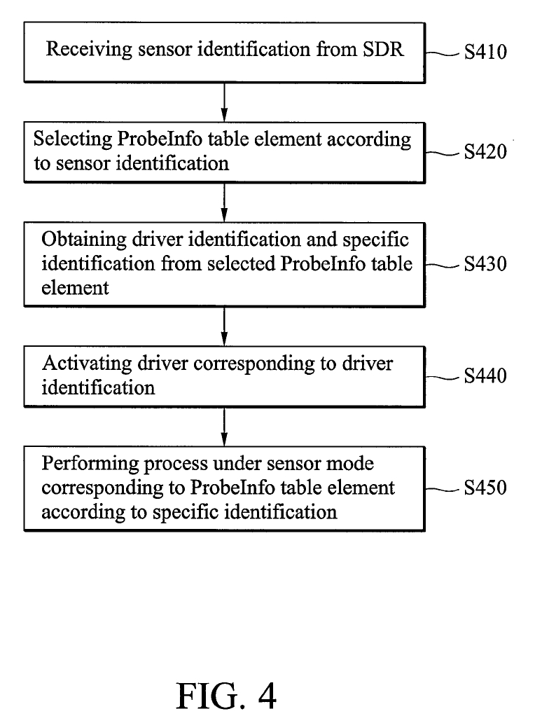

FIG. 4 is a flowchart of an embodiment of a sensor process management method.

In step S410, a sensor identification is received from a SDR, and in step S420, one of the ProbeInfo table elements is selected according to the sensor identification. It is understood that in step S420, it is determined whether the sensor identification from the SDR matches the sensor identification of any one of the ProbeInfo table elements, and one of the ProbeInfo table elements having the matched sensor identification is selected. In step S430, a driver identification and the specific identification are obtained from the selected ProbeInfo table element. In step S440, a driver (adaptive sensor driver) corresponding to the driver identification is activated. In some embodiments, a function point of the driver is obtained from the selected ProbeInfo table element, and the driver is activated referred to the function point. In some embodiments, the specific identification may be a parameter input to the driver. In step S450, a process under the sensor mode corresponding to the selected ProbeInfo table element/SDR is performed according to the specific identification by the driver. As described, the specific identification may be a parameter input to the driver. In some embodiments, the driver may have multiple processes corresponding to respective sensor modes, and have condition logics determining one of the processes to be performed according to the specific identification. It is noted that a step of providing a plurality of ProbeInfo table elements, each corresponding to one of the multiple sensor modes and recording a specific identification is executed by the storage unit or different storage units before step S410.

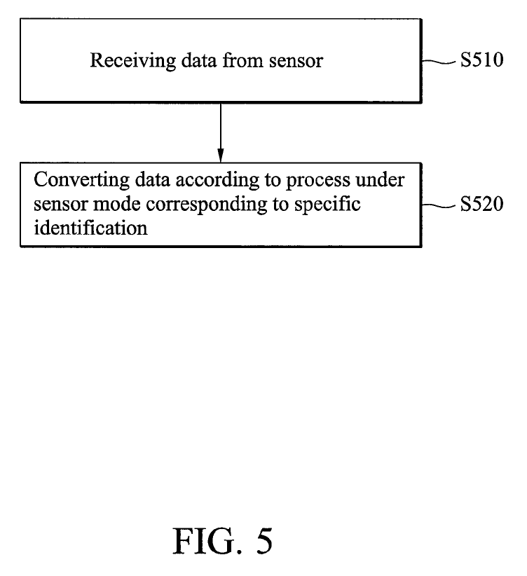

FIG. 5 is a flowchart of an embodiment of a sensor process management method for process data from a sensor. In this embodiment, a temperature sensor has two sensor modes supporting Centigrade and Fahrenheit. In step S510, data is received from the sensor, and in step S520, the data is converted according to the process under the sensor mode corresponding to the selected ProbeInfo table element/SDR. In this embodiment, the process may be a conversion equation for Centigrade or Fahrenheit. It is understood that the processes under sensor modes are examples in FIG. 5, and not limited thereto. In some embodiments, the sensor may be various, and the corresponding processes are corresponded thereto. It is understood that the processes of FIGS. 4-5 are executed by the processing unit 230 of FIG.2.

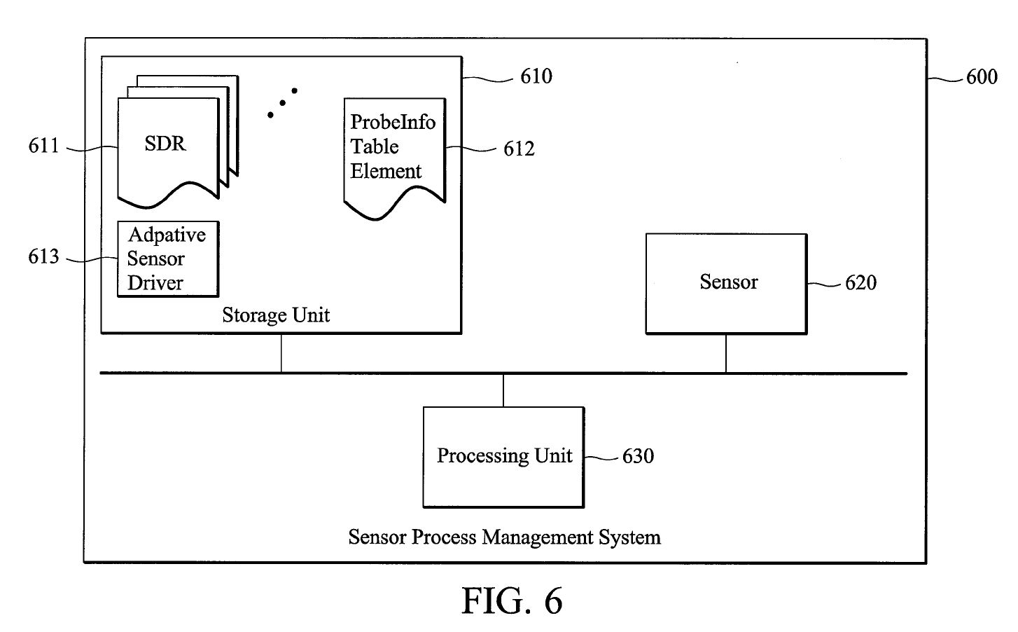

FIG. 6 is a schematic diagram illustrating an embodiment of a sensor process management system. Similarly, the sensor process management system 600 may be used in an IMPI system. The system 600 comprises at least one storage unit 610, at least one sensor 620, and at least one processing unit 630. The storage unit 610 comprises a plurality of SDRs 611, a ProbeInfo table element 612, and an adaptive sensor driver 613. In some embodiments, the ProbeInfo table element 212 and the adaptive sensor driver 613 may be a firmware of the IPMI system. The SDRs 611, the ProbeInfo table element 612 and the adaptive sensor driver 613 may be stored in the same storage unit or different storage units. It is understood that the SDRs are different with each other. The SDRs provide the properties of the individual sensors present on the board. Each SDR 611 comprises a sensor identification such as a sensor name, and a specific identification. The sensor name may be recorded in an ID string bytes field of the SDR. The specific identification may be information provided to the adaptive sensor driver 613. The ProbeInfo table element 612 records driver information such as a driver identification or function point for a driver needed for a sensor/sensor mode. The ProbeInfo table element 612 comprises a sensor identification to be matched with the SDR 612. In this embodiment, respective SDRs correspond to one of the sensor modes of the sensor 620, and have a common ProbeInfo table element 612. The adaptive sensor driver 613 can determine a specific process corresponding to a specific sensor mode to be performed according to the information from one of the SDRs.

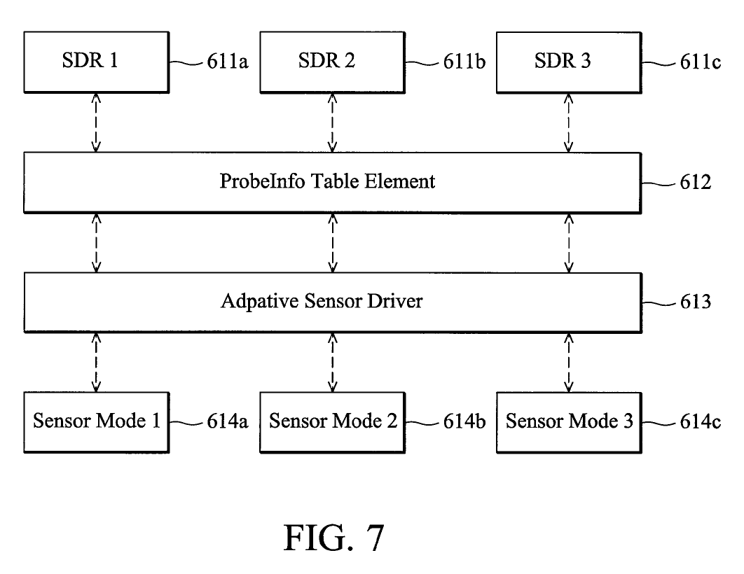

FIG. 7 is a schematic diagram illustrating the relationships among SDRs, a ProbeInfo table element, an adaptive sensor driver, and sensor modes in FIG. 6. As shown in FIG. 7, SDR 1 (611a) corresponds to sensor mode 1 (614a). SDR 2 (611b) corresponds to sensor mode 2 (614b). SDR 3 (611c) corresponds to sensor mode 3 (614c). The SDRs commonly correspond to ProbeInfo table clement 612. The adaptive sensor driver 613 performs a process corresponding to one of the sensor modes according to information from the SDRs. Similarly, only one sensor, and corresponding sensor modes, SDRs and ProbeInfo table element are discussed in this embodiment. If several sensors are in the system, the corresponding sensor modes, SDRs and ProbeInfo table element may be similar to that in FIG. 7.

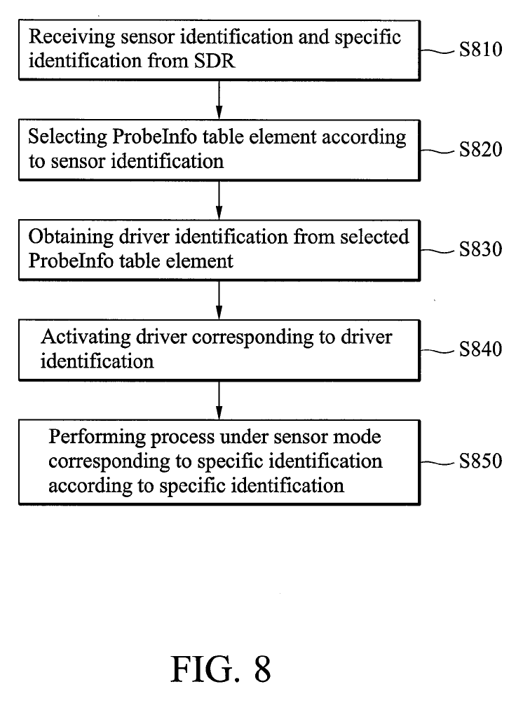

FIG. 8 is a flowchart of an embodiment of a sensor process management method.

In step S810, a sensor identification and a specific identification are received from a SDR, and in step S820, a ProbeInfo table element is selected according to the sensor identification. It is understood that in step S820, it is determined whether the sensor identification from the SDR matches the sensor identification of the ProbeInfo table element, and if so, the matched ProbeInfo table element is selected. In step S830, a driver identification is obtained from the selected ProbeInfo table element. In step S840, a driver (adaptive sensor driver) corresponding to the driver identification is activated. In some embodiments, a function point of the driver is obtained from the selected ProbeInfo table element, and the driver is activated referred to the function point. In step S850, a process under the sensor mode corresponding to the specific identification/SDR is performed according to the specific identification by the driver. In some embodiments, the specific identification may be a parameter input to the driver. In some embodiments, the driver may have multiple processes corresponding respective sensor modes, and have condition logics determining one of the processes to be performed according to the specific identification.

In this embodiment, a temperature sensor has two sensor modes supporting Centigrade and Fahrenheit. After step S850, data is received from the sensor, and then, the data is converted according to the process under the sensor mode corresponding to the ProbeInfo table element/SDR. In this embodiment, the process may be a conversion equation for Centigrade or Fahrenheit. It is understood that the processes under sensor modes are examples here, and not limited thereto. In some embodiments, the sensor may be various, and the corresponding processes are corresponded thereto. It is understood that the processes of FIG. 8 and two sequential steps described in this paragraph are executed by the processing unit 630 of FIG.6.

According to the sensor process management methods and systems of the embodiments, the firmware comprising the ProbeInfo table element and the adaptive sensor driver does not require to be changed for different clients/sensor modes. It is efficient and convenient for sensor providers.

Sensor process management methods and systems, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A sensor process management method for a sensor with multiple sensor modes, comprising:
providing a plurality of ProbeInfo table elements, each corresponding to one of the multiple sensor modes and recording a specific identification;
receiving a sensor identification from a SDR (Sensor Data Record);
selecting one of the ProbeInfo table elements according to the sensor identification;
obtaining a driver identification and the specific identification from the selected ProbeInfo table element;
activating a driver corresponding to the driver identification; and
performing a process under the sensor mode corresponding to the selected ProbeInfo table element according to the specific identification by the driver.

2. The method of claim 1, further comprising:
obtaining a function point of the driver from the selected ProbeInfo table element; and
activating the driver referred to the function point.

3. The method of claim 1, further comprising:
receiving data from the sensor; and
converting the data according to the process under the sensor mode corresponding to the selected ProbeInfo table element.

4. The method of claim 1, further comprising:
determining whether the sensor identification from the SDR matches the sensor identification of any one of the ProbeInfo table elements; and
selecting one of the ProbeInfo table elements if the sensor identification from the SDR matches the sensor identification of the selected ProbeInfo table element.

5. The method of claim 1, further comprising:
activating the driver corresponding to the driver identification with an input of the specific identification.

6. The method of claim 1, wherein the sensor identification comprises a sensor number or a sensor name.

7. A sensor process management method for a sensor with multiple sensor modes, comprising:
receiving a sensor identification and a specific identification from a SDR (Sensor Data Record), wherein the specific identification corresponds to one of the multiple sensor modes;
selecting a ProbeInfo table element according to the sensor identification;
obtaining a driver identification from the ProbeInfo table element;
activating a driver corresponding to the driver identification; and
performing a process under the sensor mode corresponding to the specific identification according to the specific identification by the driver.

8. The method of claim 7, further comprising:
obtaining a function point of the driver from the ProbeInfo table element; and
activating the driver referred to the function point.

9. The method of claim 7, further comprising:
receiving data from the sensor; and
converting the data according to the process under the sensor mode corresponding to the specific identification.

10. The method of claim 7, further comprising:
determining whether the sensor identification from the SDR matches the sensor identification of the ProbeInfo table element; and
selecting the ProbeInfo table element if the sensor identification from the SDR matches the sensor identification of the ProbeInfo table element.

11. The method of claim 7, further comprising:
activating the driver corresponding to the driver identification with an input of the specific identification.

12. The method of claim 7, wherein the sensor identification comprises a sensor name.

13. The method of claim 7, further comprising:
receiving the sensor identification and the specific identification from an ID string bytes field of the SDR.

14. The method of claim 7, further comprising:
receiving the sensor identification and the specific identification by decoding an ID string in an ID string bytes field of the SDR.

15. A sensor process management system for a sensor with multiple sensor modes, comprising:
a storage unit comprising a plurality of ProbeInfo table elements, each corresponding to one of the multiple sensor modes and recording a specific identification, and a SDR (Sensor Data Record) comprising a sensor identification; and
a processing unit receiving the sensor identification from the SDR, selecting one of the ProbeInfo table elements according to the sensor identification, obtaining a driver identification and the specific identification from the selected ProbeInfo table element, activating a driver corresponding to the driver identification, and performing a process under the sensor mode corresponding to the selected ProbeInfo table element according to the specific identification by the driver.

16. The system of claim 15, wherein the processing unit further obtains a function point of the driver from the selected ProbeInfo table element, and activates the driver referred to the function point.

17. The system of claim 15, wherein the processing unit further receives data from the sensor, and converts the data according to the process under the sensor mode corresponding to the selected ProbeInfo table element.

18. The system of claim 15, wherein the processing unit further determines whether the sensor identification from the SDR matches the sensor identification of any one of the ProbeInfo table elements, and selects one of the ProbeInfo table elements if the sensor identification from the SDR matches the sensor identification of the selected ProbeInfo table element.

19. The system of claim 15, wherein the processing unit further activates the driver corresponding to the driver identification with an input of the specific identification.

20. The system of claim 15, wherein the sensor identification comprises a sensor number or a sensor name.

21. A sensor process management system for a sensor with multiple sensor modes, comprising:
a storage unit comprising a SDR (Sensor Data Record) comprising a sensor identification and a specific identification corresponding to one of the multiple sensor modes, and a ProbeInfo table element corresponding to the sensor identification and comprising a driver identification; and
a processing unit receiving the sensor identification and the specific identification from the SDR, selecting the ProbeInfo table element according to the sensor identification, obtaining the driver identification from the selected ProbeInfo table element, activating a driver corresponding to the driver identification, and performing a process under the sensor mode corresponding to the specific identification according to the specific identification by the driver.

22. The system of claim 21, wherein the processing unit further obtains a function point of the driver from the ProbeInfo table element, and activates the driver referred to the function point.

23. The system of claim 21, wherein the processing unit further receives data from the sensor, and converts the data according to the process under the sensor mode corresponding to the specific identification.

24. The system of claim 21, wherein the processing unit further determines whether the sensor identification from the SDR matches the sensor identification of the ProbeInfo table element, and selects the ProbeInfo table element if the sensor identification from the SDR matches the sensor identification of the ProbeInfo table element.

25. The system of claim 21, wherein the processing unit further activates the driver corresponding to the driver identification with an input of the specific identification.

26. The system of claim 21, wherein the sensor identification comprises a sensor name.

27. The system of claim 21, wherein the processing unit further receives the sensor identification and the specific identification from an ID string bytes field of the SDR.

28. The system of claim 21, wherein the processing unit further receives the sensor identification and the specific identification by decoding an ID string in an ID string bytes field of the SDR.
